(19) United States
(12) Patent Application Publication
(10) Pub. No.: US 2022/0235837 A1
(43) Pub. Date: Jul. 28, 2022

(54) BRAKE PISTON, METHOD FOR MANUFACTURING A BRAKE PISTON, AND BRAKE CALIPER

(71) Applicant: ZF Active Safety GmbH, Koblenz (DE)

(72) Inventor: Michael Schog, Mertloch (DE)

(21) Appl. No.: 17/583,978

(22) Filed: Jan. 25, 2022

(30) Foreign Application Priority Data
Jan. 28, 2021 (DE) 102021101991.5
Oct. 13, 2021 (DE) 102021126462.6

(51) Int. Cl. F16D 65/18

(52) U.S. Cl. CPC F16D 65/18; F16D 2121/02

(57) ABSTRACT

A brake piston is described which comprises a first tubular piston body portion and a second tubular piston body portion. The second piston body portion is connected to the first piston body portion and lies, in an axial view, radially completely inside the first piston body portion, thus forming an annular hollow space. Furthermore, a length of the second piston body portion along a piston longitudinal axis is at least 50% of a length of the first piston body portion. An inner circumferential surface of the second piston body portion comprises an anti-rotation contour which also forms an axial guide contour for a brake piston drive. Moreover, a method for manufacturing such a brake piston is explained. A brake caliper for a disk brake of a vehicle is also presented, which brake caliper comprises such a brake piston.

### CROSS-REFERENCE TO RELATED APPLICATION

This application claims priority to German Patent Application No. 102021101991.5, filed Jan. 28, 2021 and German Patent Application No. 102021126462.6, filed Oct. 13, 2021, the disclosure of which is incorporated herein by reference in its entirety.

### TECHNICAL FIELD

The disclosure relates to a brake piston, in particular for a disk brake of a vehicle, comprising a first tubular piston body portion and a second tubular piston body portion, both of which extend along a piston longitudinal axis. The second piston body portion is connected to the first piston body portion and lies, in an axial view, radially completely inside the first piston body portion, thus forming an annular hollow space between the first piston body portion and the second piston body portion. Furthermore, the disclosure is also directed to a method for manufacturing such a brake piston. In addition, the disclosure also relates to a brake caliper for a disk brake of a vehicle, which brake caliper comprises such a brake piston.

### BACKGROUND

Brake pistons and brake calipers of the aforementioned type are known from the prior art. A position of the second piston body portion, which, in an axial view, is radially completely inside the first piston body portion, can be verified by viewing the brake piston in an axial view, i.e. along the piston longitudinal axis. In this view, the second piston body portion must lie radially completely inside the first piston body portion. For this purpose, it is irrelevant whether the second piston body portion projects or is set back in the axial direction with respect to the first piston body portion or is the same length as the first piston body portion.

The brake piston is usually slidably accommodated in a cylindrical opening which, in the case of a fluidically actuatable brake, is a fluid cylinder, and delimits a pressure chamber to which pressurized fluid can be supplied. The brake piston can therefore be moved in the direction of a brake pad by applying pressure to the pressure chamber, which brake pad is thus pressed against an associated brake disk and brakes it. A hydraulic fluid is often used as the pressurized fluid, and it is therefore also possible to refer to hydraulic actuation of the brake piston.

As an alternative or in addition, known brake pistons can also be coupled to an electrically actuatable spindle drive. In this context, the brake pad can be moved in the direction of a brake pad by actuating the spindle drive, which brake pad is thus pressed against the associated brake disk and brakes it. The brake piston can therefore also be actuated electrically. This is usually used in order to use the brake caliper in which the brake piston is arranged and the associated brake disk as a parking brake.

Methods for manufacturing brake pistons are also known per se. As a result of the high cost pressure in the field of vehicle technology, it is always important to be able to produce brake pistons with the desired properties and functions at the lowest possible manufacturing costs. The expenditure for manufacturing a brake piston depends on the manufacturing technology used and on the structural design of the brake piston to be manufactured.

### SUMMARY

Against this background, the problem addressed by the disclosure is that of providing an improved brake piston and an improved method for the manufacture thereof.

The problem is solved by a brake piston of the type mentioned at the outset, in which a length of a second piston body portion along a piston longitudinal axis is at least 50% of a length of the first piston body portion, and an inner circumferential surface of the second piston body portion comprises an anti-rotation contour for a brake piston drive, which anti-rotation contour also forms an axial guide contour for the brake piston drive. By making the second piston body portion comparatively long, the anti-rotation contour and the axial guide contour can be used to integrate functional elements which are required during operation of the brake piston into said second piston body portion. In this context, both the anti-rotation contour and the axial guide contour can interact with a spindle nut of a brake piston drive designed as a spindle drive. The anti-rotation contour and the axial guide contour are thus used to be able to slide the brake piston electrically by the spindle drive.

In one exemplary arrangement, an outer circumferential surface of the first piston body portion also comprises a running or sliding surface of the piston. In this respect, too, the brake piston is functionally integrated. At the same time, the brake piston has a simple structure with the first piston body portion and the second piston body portion. This means that it can also be manufactured with little effort. A hollow space provided between the first piston body portion and the second piston body portion results in a small amount of materials required, which also reduces the costs. The brake piston is also light in weight as a result of the hollow space.

As a result of the comparatively long second piston body portion, the hollow space can also be designed in such a way that the brake piston, when it is used in a fluid cylinder, takes up the largest possible volume on the pressure chamber side. In other words, the brake piston can be designed in such a way that a volume of the pressure chamber is kept as small as possible. Therefore, only a comparatively small amount, i.e. a comparatively small volume, of pressurized fluid is required in order to actuate the brake piston. Moreover, due to the fact that there is only a small amount of pressurized fluid within the pressure chamber, only a comparatively low resilience of the brake system, which resilience results from compressing the pressurized fluid, has to be compensated for when the brake piston is actuated. In other words, the brake piston is designed so that it can be actuated quickly, precisely and reliably. This is also referred to as good response behavior. Moreover, the shape of the brake piston means that, in particular, a volume-reducing piece, also called a spacer, can be omitted.

Due to the fact that the second piston body portion is separated from or offset from the first piston body portion by the hollow space, a diameter of the first piston body portion can be selected substantially independently of a diameter of the second piston body portion. For example, a diameter of the first piston body portion can be changed, while a diameter of the second piston body portion is kept unchanged. As a result, the anti-rotation contour and the axial guide contour also remain the same. In this way, the brake piston can be easily adapted for use in different brake calipers. At the same time, in each of these uses, the brake piston can be designed to interact with a uniform, for example standardized, brake piston drive via the anti-rotation contour and the axial guide contour. The brake piston can therefore be used extremely flexibly.

The brake piston according to the disclosure can be used in a brake that can be actuated both fluidically and via an electric brake piston drive which comprises a spindle drive, for example. It is also possible to use the brake piston in a brake that can only be actuated fluidically. The brake piston according to the disclosure can also be used in a brake that can only be actuated by an electric brake piston drive, i.e. in a purely electromechanical brake.

In one exemplary arrangement, the first piston body portion and the second piston body portion are connected via an annular front wall portion. In one exemplary arrangement, the front wall portion also delimits the annular hollow space. A brake piston of this kind is structurally simple and can therefore be manufactured simply and inexpensively. This applies in particular to the case in which the first piston body portion transitions substantially continuously into the first piston body portion via the front wall portion. As a result of the aforementioned long axial length of the second piston body portion, the annular front wall portion is also arranged such that it protrudes relatively far into a pressure chamber when the brake piston is used in a cylindrical opening, e.g. a fluid cylinder. The effects and advantages mentioned above in conjunction with a comparatively small volume of the pressure chamber are therefore enhanced further.

In one exemplary arrangement, the second piston body portion can also be axially closed by a base portion. The second piston body portion and the base portion thus together form a type of pot or a cavity. In one exemplary arrangement, the base portion is used as an axial stop for the brake piston drive. This function is therefore also integrated into the brake piston, which is why it can be produced easily and inexpensively given its functional scope.

In one exemplary arrangement, the base portion and the front wall portion are arranged at axially opposite ends of the second piston body portion. An interior of the second piston body portion is therefore closed at a first axial end which, in particular when the brake piston is installed, is on the brake disk side. The front wall portion therefore closes the annular hollow space at a second axial end opposite the first, i.e. on the pressure chamber side. A brake piston of this kind is structurally simple and can be manufactured inexpensively.

The base portion can be flat, conical or frustoconical. A central axis assigned to the conical shape or the frustoconical shape is always identical to the piston longitudinal axis. Base portions of this kind form a reliable stop for the brake piston drive.

In one exemplary arrangement, a pressure surface for acting on a brake pad is positioned at one axial end of the first piston body portion. The pressure surface can be formed by an axial front face of the first piston body portion. It is also possible for the pressure surface to be supplemented with radially inwardly protruding extensions of the front face. Extensions of this kind can be produced by forming an axial end of the first piston body portion in a radially inward direction. The pressure surface can be structured in order to prevent it from sticking to the brake pad. In particular, the pressure surface has knurling or a similar structure in this regard.

The pressure surface and an axially outer end surface of the base portion can lie substantially in one plane. Alternatively, the axially outer end surface of the base portion is set back axially with respect to the pressure surface, i.e. into the interior of the piston body. In a first alternative arrangement, the pressure surface and the end surface of the base portion can thus be used to actuate a brake pad. The brake pad is therefore actuated via a comparatively large, planar contact. In a second alternative arrangement, the base portion remains at a distance from the associated brake pad even when the brake piston is actuated. In this way, too, the brake pad can be reliably actuated.

According to one exemplary arrangement, the second piston body portion is elastically displaceable in the axial direction with respect to the first piston body portion. As a result, the brake piston can be elastically deformed to a small extent in the axial direction when it abuts against the brake pad, so that it is elastically tensioned against the brake pad. In this way, the brake pad can be held in abutment against an associated brake disk with a particularly high level of reliability.

The second piston body portion can be shaped conically with respect to the piston longitudinal axis. The second piston body portion therefore has the shape of a lateral surface of a conic frustum. A conical or cone angle is in this case may be comparatively small. It is only a few degrees, for example. The second piston body portion therefore only has a slight conicity. If the brake piston is used in a spatial orientation in which a piston longitudinal axis extends substantially horizontally, air bubbles or other foreign bodies that may be trapped in a pressurized fluid can simply flow back out of a region of the second piston body portion. This keeps the susceptibility of the brake piston to failures to a minimum.

In one exemplary arrangement, the second piston body portion has a polygonal cross section. The anti-rotation contour and the axial guide contour are therefore also formed by the polygonal cross section. The cross section is square, hexagonal or octagonal, for example. Cross sections of this kind can be manufactured simply and inexpensively using common manufacturing methods.

According to one exemplary arrangement, the brake piston comprises a substantially constant wall thickness. In particular, the brake piston is a sheet metal component. A brake piston of this kind is structurally simple and can be manufactured simply and reliably. In this context, the wall thickness is also referred to as being substantially constant if local geometric elements such as grooves or the like are provided on the piston. In other words, geometric elements of this kind are disregarded when determining the wall thickness.

According to a further exemplary arrangement, the brake piston can be a deep-drawn part, a cast part or a 3D-printed part.

Metals which are either pure or in the form of alloys, for example aluminum, or plastics materials, synthetic resins or ceramics can be used as materials for the brake piston, for example.

In one exemplary arrangement, the brake piston can be manufactured in one piece, in particular by a forming or deep drawing method, a casting method or a 3D-printing method. The brake piston is therefore particularly simple and can be manufactured extremely efficiently, especially in large numbers.

In the case of additive manufacturing using a 3D-printing process, more complex geometries such as undercuts required by the design can be created more easily than a forming method or a casting method.

If the brake piston is manufactured in a plurality of pieces, i.e. is constructed of at least two brake piston parts, the manufacturing process which is most suitable in terms of the geometry and the load occurring on the relevant brake piston part during operation can be selected for each brake piston part. For example, if the brake piston is manufactured in two pieces, one brake piston part can comprise the first tubular piston body portion and be manufactured as a cast part, and the other brake piston part can comprise the second tubular piston body portion and be manufactured as a deep-drawn part.

It goes without saying that, in the case of a brake piston manufactured in a plurality of pieces, the individual brake piston parts can be reliably connected to one another by known integral and/or interlocking connections, for example welding, since these connections are simple to produce in terms of manufacturing and meet requirements such as tightness and mechanical strength.

In addition to the above, a method for manufacturing a brake piston according to the disclosure is provided herein. In one exemplary arrangement of the proposed method, the brake piston or brake piston parts is/are manufactured by deep drawing a tube that is closed at one end or a disk. The anti-rotation contour and the axial guide contour are produced by deep drawing. A method of this kind is efficient since no additional method steps are required for manufacturing the anti-rotation contour and the axial guide contour. In addition, deep drawing methods are particularly well suited to large-scale manufacturing.

If a disk is used as the starting material for the deep drawing method, this disk is first formed into a cup or a tube that is closed at one end. A central portion of the base of the cup or of the tube that is closed at one end is then deformed into the interior of same. The outer portion that is manufactured first forms the first piston body portion and the inner portion that is manufactured afterwards forms the second piston body portion.

If the brake piston is manufactured by deep drawing a tube that is closed at one end, the first forming step for manufacturing the cup is omitted.

As previously mentioned, a method for manufacturing a brake piston according to the disclosure is also disclosed, wherein the brake piston or brake piston parts is/are manufactured by a forming or deep drawing method, a casting method or a 3D-printing method.

Moreover, a brake caliper of the type mentioned at the outset, which brake caliper comprises a brake piston according to the disclosure is also provided. The brake piston is slidably accommodated in a cylindrical opening. The cylindrical opening is e.g. a fluid cylinder. In this case, the brake piston delimits a pressure chamber to which pressurized fluid can be supplied. As an alternative or in addition, the brake piston is coupled to a brake piston drive comprising a spindle drive. Due to the fact that the brake piston according to the disclosure is structurally simple and can be manufactured inexpensively, this is also the case with the brake caliper in which a brake piston of this kind is used.

If the brake piston is slidably accommodated in the fluid cylinder and delimits the pressure chamber, the brake piston can be actuated fluidically, for example hydraulically.

If the brake piston is only coupled to a brake piston drive comprising a spindle drive, said brake piston can only be actuated electrically by the spindle drive. A brake caliper of this kind can be used for a parking brake. In this context, this is also referred to as an electric park brake (EPB). A brake caliper of this kind can also be used for an electromechanical brake (EMB) which is also used while driving.

Of course, it is also possible for the brake piston to be accommodated in a fluid cylinder and delimit a pressure chamber and for the brake piston to also be coupled to a brake piston drive comprising a spindle drive. All of the above functions can then be carried out.

The brake piston drive can have a cross-sectional geometry that is complementary to the anti-rotation contour in the region with which the brake piston drive protrudes into the anti-rotation contour. In one exemplary arrangement, the region is formed by a spindle nut. The spindle nut is therefore mounted on the brake piston so as to be secured against rotation and such that it can slide along the piston longitudinal axis. This produces a reliable coupling between the brake piston and the brake piston drive. In this context, a spindle of the spindle drive is mounted so as to be rotatably stationary.

### BRIEF DESCRIPTION OF DRAWINGS

The disclosure is explained below with reference to various exemplary arrangements which are shown in the accompanying drawings, in which:

FIG. 1 is a partial sectional view of a brake caliper according to the disclosure comprising a brake piston according to the disclosure, which brake piston has been manufactured by a method according to the disclosure, a portion of a brake disk also being shown,

FIG. 2 shows the brake piston according to the disclosure from FIG. 1 together with components of a brake piston drive designed as a spindle drive,

FIG. 3 is an isolated view of the brake piston from FIGS. 1 and 2,

FIG. 4 is a view of the brake piston from FIG. 1 to 3 along a direction IV from FIG. 3,

FIG. 5 is a perspective view of the brake piston from FIG. 1 to 4,

FIG. 6 is a different perspective view of the brake piston from FIG. 1 to 4, and

FIG. 7 is a view, corresponding to FIG. 2, of a variant of the brake piston according to the disclosure.

### DETAILED DESCRIPTION

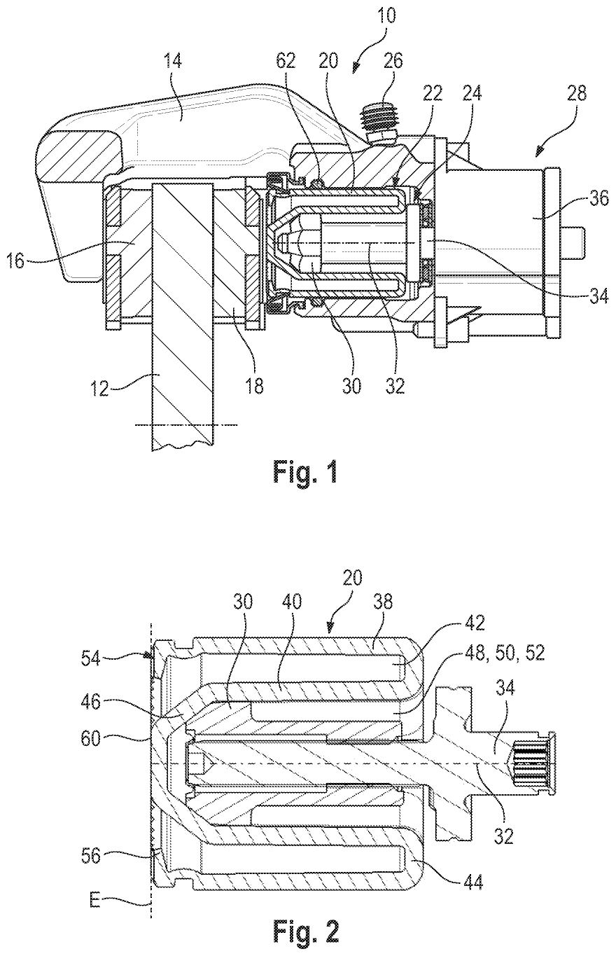

FIG. 1 shows a brake caliper 10 of a disk brake of a vehicle, which brake caliper interacts with a brake disk 12.

The brake caliper 10 comprises a brake caliper body 14 to which a first brake pad 16 is fastened. The first brake pad 16 is thus held immovably on the brake caliper body 14.

In addition, a second brake pad 18 is provided which is slidably mounted on the brake caliper body 14 so that it can optionally be pressed against the brake disk 12 by a brake piston 20 in order to achieve a braking effect.

For this purpose, the brake piston 20 is slidably mounted in a cylindrical opening, in this case e.g. a fluid cylinder 22, which is formed on the brake caliper body 14.

In this case, a pressure chamber 24 to which pressurized fluid can be supplied is delimited by an end of the fluid cylinder 22 facing away from the brake disk 12 and by the brake piston 20.

The pressure chamber 24 is fluidically connected to a pressurized fluid connection 26 via which a pressurized fluid can optionally be introduced into the pressure chamber 24 and discharged therefrom.

The pressurized fluid is a hydraulic fluid, for example. The fluid cylinder 22 is therefore a hydraulic cylinder.

The brake piston 20 can therefore be moved hydraulically toward the brake pad 18 and the brake disk 12, so that the brake pad 18 abuts against the brake disk 12 and brakes it.

Moreover, the brake piston 20 is coupled to a brake piston drive 28 which, in the exemplary arrangement shown, is a spindle drive.

It should be emphasized, however, that the brake piston having the functions described above and below can also be used in a purely electromechanical brake and is accommodated in this case in a cylindrical opening which can be designed as a bore or as an opening in a tubular cylinder.

In this context, a spindle nut 30 of the spindle drive is mounted on the brake piston 20 such that it cannot be rotated but can be slid axially along a piston longitudinal axis 32.

The spindle nut 30 interacts with a spindle 34 of the spindle drive, which spindle is mounted on the brake caliper body 14 such that it can be rotated about the piston longitudinal axis 32 but is otherwise stationary. The spindle 34 can optionally be set in rotation by an electric drive motor 36.

The brake piston 20 can therefore also be moved toward the brake pad 18 and the brake disk 12 by the brake piston drive 28 designed as a spindle drive, so that the brake pad 18 is pressed against the brake disk 12 and brakes it.

The brake piston 20 is shown in detail in FIG. 2 to 6. In addition, the spindle nut 30 and the spindle 34 can be seen in FIG. 2.

In this context, in one exemplary arrangement, the brake piston 20 is substantially composed of a first tubular piston body portion 38 and a second tubular piston body portion 40.

The two piston body portions 38, 40 extend along the piston longitudinal axis 32.

The second piston body portion 40 is in this exemplary arrangement is designed to be slightly conical with respect to the piston longitudinal axis 32. Starting from the end which is arranged adjacent to the brake piston drive 28, the cross section of said second piston body portion decreases in the direction of the end on the brake pad side.

Furthermore, the second piston body portion 40 is arranged, in an axial view, radially completely inside the first piston body portion 38, thus forming an annular hollow space 42. In other words, the second piston body portion 40 lies completely inside the first piston body portion 38 when the brake piston 20 is viewed along the piston longitudinal axis 32.

In the exemplary arrangement shown, the second piston body portion 40 also lies axially completely inside the first piston body portion 38. This means that the second piston body portion 40 does not project axially beyond the first piston body portion 38. This applies to both axial ends of the second piston body portion 40.

In this case, the first piston body portion 38 and the second piston body portion 40 are connected to one another via an annular front wall portion 44. The annular front wall portion 44 thus also delimits the hollow space 42 in the axial direction.

In addition, the second piston body portion 40 is axially closed, by a base portion 46, at its end opposite the front wall portion 44 along the piston longitudinal axis 32.

In the exemplary arrangement shown, the base portion 46 is frustoconical. It goes without saying, however, that this base portion can also be shaped differently, e.g. so as to be flat or conical.

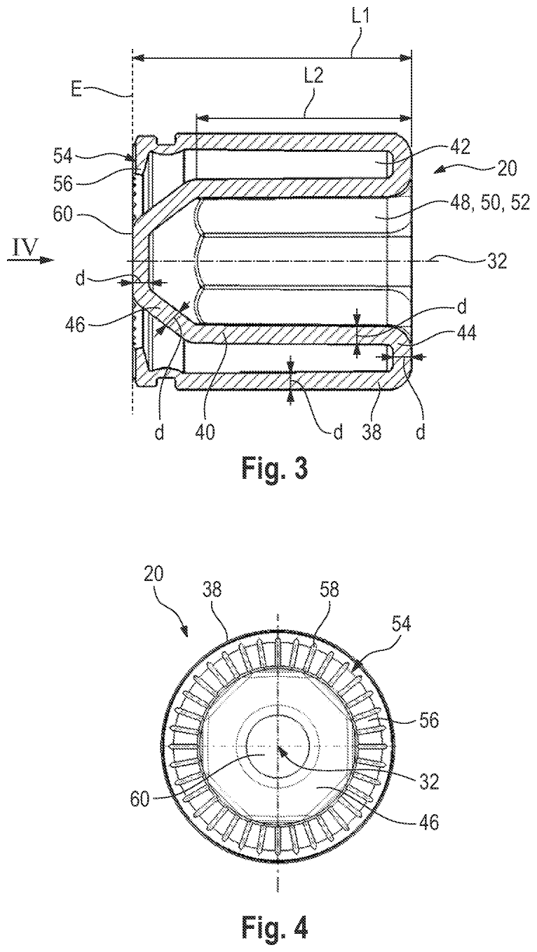

In the exemplary arrangement shown, a length L2 of the second piston body portion 40 is 70% to 80% of a length L1 of the first piston body portion 38 (see FIG. 3).

Of course, other lengths L2 of the second piston body portion 40 are also possible. As will become clear from the following explanation, however, a minimum length must be specified. Overall, a length L2 of the second piston body portion 40 along the piston longitudinal axis 32 is at least 50% of the length L1 of the first piston body portion 38.

The second piston body portion 40 and the base portion 46 together form a cavity in which the spindle nut 30 is received.

An inner circumferential surface 48 of the second piston body portion 40 has an anti-rotation contour 50.

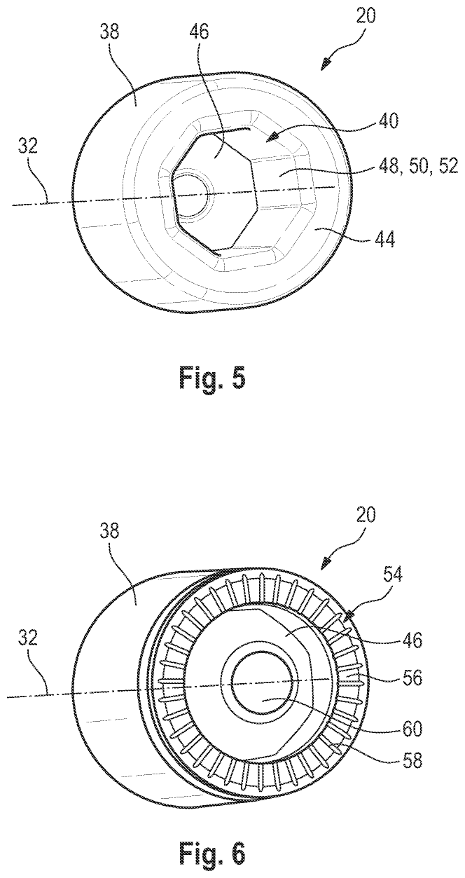

In the exemplary arrangement shown, the anti-rotation contour 50 is formed by the second piston body portion having an octagonal cross section (see in particular FIG. 5).

The spindle nut 30, which represents a region of the brake piston drive 28 which protrudes into the anti-rotation contour 50, has a complementary cross-sectional geometry, i.e. is also octagonal. This means that the spindle nut 30 cannot be rotated relative to the brake piston 20.

However, the spindle nut 30 can be slid along the piston longitudinal axis 32 within the second piston body portion 40.

The inner circumferential surface 48 thus also forms an axial guide contour 52 for the brake piston drive 28, more precisely for the spindle nut 30.

The aforementioned conicity of the second piston body portion 40 is so slight that the spindle nut 30 can be guided over the entire length L2 due to the guide contour 52.

In addition, a pressure surface 54 is positioned at an axial end of the first piston body portion 38, which pressure surface is used to abut against the brake pad 18, i.e. to apply a force thereto.

The pressure surface 54 extends over the axial front surface of the first piston body portion 38 and over an annular pressure surface extension 56 extending radially inward from the front surface.

In order to increase the friction between the brake pad 18 and the pressure surface 54, said pressure surface is provided with radial grooves 58.

In order to prevent the brake piston 20 from rotating relative to the brake caliper body 14, said brake piston is non-rotatably connected e.g. to the brake pad 18, usually to the so-called back plate of the brake pad 18, via a mechanical coupling. For example, a projection is provided on the brake piston 20 or on the back plate, which projection engages in the other component of the brake piston 20 and back plate in order to produce a non-rotatable coupling.

The brake piston 20 is also designed in such a way that the pressure surface 54 and an axially outer end surface 60 of the base portion 46 lie substantially in one plane E (see FIGS. 2 and 3).

When the brake piston 20 is in operation, not only the pressure surface 54 but also the end surface 60 abuts against the brake pad 18.

As can be seen in particular from FIG. 3, the brake piston 20 has a substantially constant wall thickness d.

In this exemplary arrangement, the brake piston 20 is manufactured in one piece as a sheet metal component.

In the exemplary arrangement shown, the brake piston 20 is manufactured by a deep drawing method.

A disk is used as the starting material.

This is first formed into a cup or a tube that is closed at one end. A lateral surface of the cup or the tube substantially corresponds to the first piston body portion 38 in terms of its outer contour.

A central base region of the cup or the tube is then deformed in the direction of the interior of the cup or the tube. This produces the second piston body portion 40 and the base portion 46.

The regions of the base of the cup or tube that are not ultimately deformed form the annular front wall portion 44.

Optionally, the pressure surface extension 56 is lastly formed by an end of the first piston body portion 38 opposite the front wall portion 44 being formed radially inward.

Alternatively, a tube that is closed at one end can also be selected as the starting material. In the method described above, the first step in which the disk is deformed to form such a tube can then be omitted.

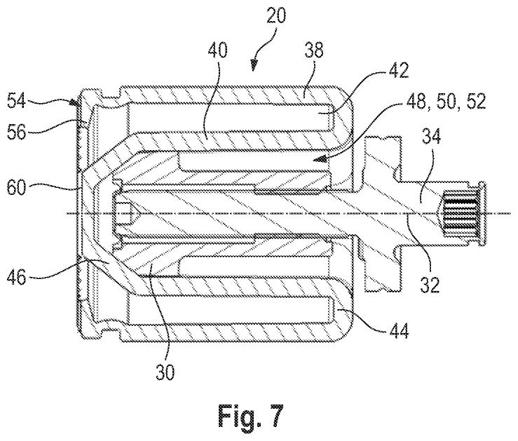

A variant of the brake piston 20 together with the spindle nut 30 and the spindle 34 is shown in FIG. 7.

The brake piston 20 according to the exemplary arrangement in FIG. 7 only differs from the brake piston 20 explained with reference to FIG. 1 to 6 in that the outer end surface 60 of the base portion 46 is set back axially with respect to the pressure surface 54, i.e. is set back along the piston longitudinal axis 32.

In the exemplary arrangement according to FIG. 7, in a situation in which the brake piston 20 acts on the brake pad 18, there is thus a free space between the end surface 60 of the base portion 46 and the brake pad 18. The second piston body portion 40 can therefore be displaced elastically toward the brake pad 18 in the axial direction with respect to the first piston body portion 38. This results in particular from an elastic deformation of the annular front wall portion 44.

This makes it possible for the brake piston 20 to abut against the brake pad 18 under elastic tension, for example when actuated by the brake piston drive 28 and in particular by the spindle nut 30.

The brake caliper 10 can be operated as follows.

Starting from the position of the brake piston 20 shown in FIG. 1, said brake piston can be moved to the left, for example by applying pressure to the pressure chamber 24, so that it abuts against the brake pad 18 and presses said brake pad against the brake disk 12. This creates a braking effect.

In this context, the brake piston drive 28 is not actuated, i.e. the spindle nut 30 does not move.

When moved in the direction of the brake pad 18, there is therefore a relative movement between the brake piston 20 and the spindle nut 30. This is made possible by the axial guide contour 52.

Alternatively, it is possible for the brake piston 20, starting from the position shown in FIG. 1, to be moved to the left by the brake piston drive 28. For this purpose, the electric drive motor 36 is activated and the spindle 34 is set in rotation. Once the spindle nut 30 is non-rotatably mounted on the brake piston 20 via the anti-rotation contour 50, the spindle nut 30 is thereby moved to the left. In this case, it is guided by the guide contour 52.

As soon as the spindle nut 30 strikes against the base portion 46 of the brake piston 20, it entrains the brake piston 20 with it as it moves to the left.

In so doing, the brake piston 20 abuts against the brake pad 18, which in turn is pressed against the brake disk 12 in order to produce a braking effect.

In this context, in addition to the aforementioned rotary coupling with the back plate, the brake piston 20 is frictionally held on the brake caliper body 14 as a result of its frictional contact with a seal 62, so that it does not rotate.

As soon as the brake piston 20 is in contact with the brake pad 18, this system also causes the brake piston to be secured against rotation within the brake caliper body 14.

If the brake piston is designed according to FIG. 7, the second piston body portion 40 and the base portion 46 can be moved a little further by elastically deforming the front wall portion 44 relative to the first piston body portion 38, the pressure surface 54 of which abuts against the brake pad 18. The brake piston 20 is thus placed under tension.

1. A brake piston (20), in particular for a disk brake of a vehicle, comprising a first tubular piston body portion and a second tubular piston body portion, both of which extend along a piston longitudinal axis,
the second piston body portion being connected to the first piston body portion and lying, in an axial view, radially completely inside the first piston body portion, thus forming an annular hollow space between the first piston body portion and the second piston body portion,
wherein a length of the second piston body portion along the piston longitudinal axis is at least 50% of a length of the first piston body portion, and an inner circumferential surface of the second piston body portion comprises an anti-rotation contour for a brake piston drive, which anti-rotation contour also forms an axial guide contour for the brake piston drive.

2. The brake piston according to claim 1, wherein the first piston body portion and the second piston body portion are connected via an annular front wall portion.

3. The brake piston according to claim 1, wherein the second piston body portion is axially closed at one end by a base portion.

4. The brake piston according to claim 2, wherein the base portion and the front wall portion are arranged at axially opposite ends of the second piston body portion.

5. The brake piston according to claim 4, wherein the base portion is flat, conical or frustoconical.

6. The brake piston according to claim 1, wherein a pressure surface for acting on a brake pad is positioned at one axial end of the first piston body portion.

7. The brake piston according to claim 6, wherein the pressure surface and an axially outer end surface of the base portion lie substantially in one plane.

8. The brake piston according to claim 1, wherein the second piston body portion is elastically displaceable in then axial direction with respect to the first piston body portion.

9. The brake piston according to claim 1, wherein the second piston body portion is shaped conically with respect to the piston longitudinal axis.

10. The brake piston according to claim 1, wherein the second piston body portion has a polygonal cross section.

11. The brake piston according to claim 1, wherein the brake piston has a substantially constant wall thickness.

12. The brake piston according to claim 1, wherein the brake piston is manufactured in one piece.

13. A method for manufacturing a brake piston according to claim 1, wherein the brake piston or brake piston parts is/are manufactured by deep drawing a tube that is closed at one end or a disk, it being possible to produce the anti-rotation contour and the axial guide contour the deep drawing.

14. The method for manufacturing a brake piston according to claim 1, wherein the brake piston or brake piston parts is/are manufactured by a forming or deep drawing method, a casting method or a 3D-printing method.

15. A brake caliper for a disk brake of a vehicle, comprising a brake piston according to claim 1,
wherein the brake piston is slidably accommodated in a cylindrical opening and/or wherein the brake piston is coupled to a brake piston drive comprising a spindle drive.

16. The brake caliper according to claim 15, wherein the brake piston drive has a cross-sectional geometry that is complementary to the anti-rotation contour in the region with which the brake piston drive protrudes into the anti-rotation contour.

17. The brake piston according to claim 6, wherein an axially outer end surface of the base portion is set back axially with respect to the pressure surface.

18. The brake piston according to claim 11, wherein the brake piston is a sheet metal component.

19. The brake piston according to claim 12, wherein the brake piston is one of a deep-drawn part, a cast part or a 3D-printed part.

20. The brake piston according to claim 3, wherein the base portion and the front wall portion are arranged at axially opposite ends of the second piston body portion.
